(19) United States
(12) Patent Application Publication
(10) Pub. No.: US 2013/0004910 A1
(43) Pub. Date: Jan. 3, 2013

(54) SYSTEM FOR POSITIONING ORTHODONTIC COMPONENTS

(76) Inventor: Thomas Halbich, Berlin (DE)

(21) Appl. No.: 13/574,784

(22) PCT Filed: Jan. 24, 2011
(86) PCT No.: PCT/DE2011/075008

§ 371 Date: Sep. 13, 2012

(30) Foreign Application Priority Data
Jan. 26, 2010 (DE) 20 2010 001 323.2

(51) Int. Cl. A61C 7/02

(52) U.S. Cl. 433/3

(57) ABSTRACT

The invention relates to a system for positioning orthodontic components, more particularly orthodontic brackets, with a base structure made of elastic material, at least one dental cap, which is detachably arranged on the base structure by means of a coupling device and on the underside has a retention fixture corresponding to a tooth for interlocking mounting on the tooth, and at least one bracket holder, which is formed on the at least one dental cap and which is configured to position an orthodontic component on the corresponding tooth at least partially outside the retention fixture when mounting the at least one dental cap.

The disclosure relates to a system for positioning orthodontic components, more particularly orthodontic brackets.

### BACKGROUND

Such systems are used for positioning one or more orthodontic components, which can also be designated as brackets, orthodontic devices or dental regulating devices, on an corresponding tooth so that the bracket can be fastened thereto in a required position. More particularly, in conjunction with orthodontic treatments, orthodontic brackets are used to create dental braces in which the brackets attached to the teeth can then be connected by means of a wire. Brackets are known, for example, in the form of ceramic, plastic or metal brackets. Usually on the side facing away from the assigned tooth they have a retention fixture in which the wire connecting the several brackets is held.

In the production of the orthodontic device, a model of the future wearer's row of teeth is first produced. The brackets are then positioned on the teeth of the model in the way they are to be subsequently arranged on the patient's teeth. Systems, also known as transfer systems, are then used to transfer the brackets arranged on the model of the row of teeth to the patient's teeth while retaining the positioning determined on the model. A transfer system of this type is known from document DE 10 2006 020 010 A1 in which a transfer film, to which the brackets adhere, is used as a transfer aid.

Document U.S. Pat. No. 5,055,039 discloses a so-called transfer matrix, which on the inside has several segments corresponding to individual teeth, to each of which an orthodontic component is attached. The components to be attached to the corresponding tooth are held detachably on the relevant segment, so that after adhering the components to the teeth the transfer matrix with the segments formed thereon can be removed and separated from the orthodontic components, which remain on the teeth. The transfer components are detachably fastened to the segments in the transfer matrix in the area of surface of the relevant segment facing the corresponding tooth. A snap lock is used to attach the components to the relevant segment.

A transfer system for brackets is also known from document U.S. Pat. No. 5,551,096 in which several retaining pockets are formed in a transfer matrix each of which contains a bracket holder. After arranging the bracket holders with the bracket held thereon on the patient's teeth, the transfer matrix is removed and the bracket holders with the brackets remain on the corresponding teeth.

In document U.S. Pat. No. 3,738,005 a transfer device is used for transferring brackets from a model of a row of teeth to the patient's teeth in which the brackets adhere to a transfer matrix which is removed after fastening the brackets on the patient's teeth.

### SUMMARY

It is an object of the invention to provide an improved system for positioning orthodontic components, more particularly orthodontic brackets, which on the one hand makes exact positioning of the components on the patient's teeth possible for the user and on the other hand provides as much flexibility as possible with regard to different orthodontic treatment situations.

A system is provided for positioning orthodontic components, more particularly orthodontic brackets, according to independent claim 1. Advantageous embodiments form the subject matter of the dependent sub-claims.

A system is provided for positioning orthodontic components, more particularly orthodontic brackets, with a base structure made of elastic material, at least one dental cap which is detachably arranged on the basic structure by means of a coupling device and on the underside has a retention fixture facing a tooth for interlocking mounting on the tooth, and at least one bracket holder which is formed and configured on the at least one dental cap to position an orthodontic component on the corresponding tooth at least partially outside the retention fixture when mounting the at least one dental cap.

The system allows the user, for example a treating dentist or orthodontist, to precisely position one or more orthodontic components, more particularly brackets, on the corresponding teeth of the patient, namely the surface of the teeth, as well as to fit the base structure made of elastic material with dental caps as required depending on the situation and treatment. The dental caps are detachably fastened to the base structure with the aid of the coupling device. In this way specific fitting of one or more of the patient's teeth with a corresponding component is made possible. The interlocking mounting of one or more dental caps on one or more of the patient's teeth ensures the exact positioning of one or more corresponding components which are arranged on the relevant component holder. Interlocking mounting is achieved in that in the retention fixture of the dental cap a negative impression of a section of the surface of the corresponding tooth is formed. The dental anatomically-shaped retention fixture is created in the usual way, for example using a dental model of the patient. In the created system the interlocking mounting on the corresponding tooth is not disrupted by external elements, as the component holder holds the components outside the retention fixture. By contrast, in the prior art the bracket holder and/or the bracket itself restrict interlocking mounting in the area of the retention fixture of the dental cap. Such disruptive influences are avoided in the system for positioning orthodontic brackets proposed here.

The system can be configured for use on the upper or on the lower jaw. The component holder is configured to position the component fully or partially outside the retention fixture.

The one or more dental caps can correspond to one or more teeth. Thus, one dental cap can also be produced for several teeth together. In connection with this, in one embodiment it can be envisaged that on the dental cap designed for several teeth together a component holder for the teeth is arranged which is configured to arrange the relevant component on the inside and/or the outside of the row of teeth.

Preferably the base structure is made of an elastic material, more particularly a plastic or silicone material. As part of production the elastic material is provided, for example, as a casting compound.

All manner of embodiments of components, more particularly brackets can be used. For example, the component can be made of a ceramic, plastic or metal material. Depending on the form of embodiment the component can also be of any design. More particularly, orthodontic components also include designs in which so-called rod or button attachments are formed on the component adapter and are in contact with the tooth surface, either on the outside or inside of the row of teeth, whereby the tooth can be on the upper or lower jaw.

A preferred further embodiment envisages that the coupling device is formed with a coupling component on the at least one dental cap and a corresponding coupling component on the base structure, whereby the coupling component and the corresponding coupling component couple in a detachable manner. The coupling component on the at least one dental cap and/or the corresponding component on the base structure can be designed as a cylindrical component. In this or other embodiments the coupling component has, for example, a base section and coupling section formed thereon in which coupling with the corresponding coupling component on the base structure is brought about. It can be envisaged that the corresponding coupling component is inserted, for example detachably, into the base structure. However, the corresponding coupling component can also be designed in one part with the base structure. In one easily realisable form of embodiment a recess is formed on the base structure into which the coupling component of the at least one dental cap engages to produce the coupling. Through this, in a further development a type of snap connection can be produced. For example a section of the corresponding coupling component on the at least one dental cap, for example a spherical head, snaps into a recess in the elastic material of the base structure.

In an expedient embodiment it can be envisaged that the at least one component holder is arranged on the coupling component. The component holder can be produced in one piece with the coupling component. In another form of embodiment the component holder is arranged on the coupling components. For example a flat section of the component holder is introduced into a slit-like retention fixture on the coupling component. The component holder can be fastened to the coupling component in a detachable manner. In the form of embodiment of the coupling component with a base section it can be envisaged that the retention fixture for the component holder is located in the base section.

An advantageous form of embodiment envisages that the coupling component is at least partially set into the at least one dental cap and/or the corresponding component is at least partially set into the basic structure. For example, the coupling component with the base section is set into the corresponding dental cap, preferably so that an upper sider of the base section is essentially flush with an outer surface of the dental cap.

Preferably a further development envisages that the coupling component has a coupling structure which is still configured to couple to a positioning aid in an uncoupled position in which the at least one dental cap is uncoupled from the base structure. In this form of embodiment the coupling structure on the coupling component, which is formed on the dental cap serves to form the coupling device in that the coupling structure interacts with the corresponding coupling component on the base structure. On the other hand, in the uncoupled state in which the at least one dental cap is uncoupled from the base structure, the coupling structure is configured to couple to a positioning aid, for example a manual positioning pin, which allows the user to position the dental cap on the tooth. For example, a tip of the manual positioning aid engages in the coupling structure, preferably in an interlocking manner. The tip of the manual positioning aid can for example be designed with a spherical head which engages in a coupling structure designed as a spherical retention fixture on the coupling component. In connection with this, or in other embodiments in which, for example, the spherical head is formed on the coupling component and a corresponding retention fixture on the manual positioning means, a snap connection can be provided, into which the spherical head snaps when the manual positioning aid is used by the user to move the dental cap onto the corresponding tooth.

In an advantageous embodiment it can be envisaged that in a coupled state in which the at least one dental cap is coupled to the base structure, the coupling device is essentially completely surrounded by the base structure. This means in one embodiment that the coupling device is not essentially visible from outside.

A further development can envisage that the coupling device is produced with a snap coupling.

A preferred further development envisages that the at least one component holder has on the at least one dental cap a holding arm and a component adapter formed thereon, on which the component is held in a detachable manner. Alternatively non-detachable fastening can be provided. The holding arm is designed in the form of a strap, for example, more particularly a wire or metal strap at the distal end of which the component adapter is arranged.

In an expedient embodiment it can be envisaged that the at least one component holder is detachably arranged on the at least one dental cap. For example the component holder is detachably fastened to the corresponding dental cap by means of a plug connection. Here it can be envisaged that an upper section of the component holder is inserted into a corresponding retention pocket on the dental cap or pushed through an aperture. The retention pocket/the aperture is produced in the base section of the coupling component. In another form of embodiment the component holder is detachably arranged on a laterally projecting assembly component, for example by mounting on the laterally projecting assembly component. In one form of embodiment the latter can be formed on the coupling component, for example by being designed in one part with the coupling component. The laterally projecting assembly component can be formed on the base section of the coupling component in one embodiment. And in one form of embodiment the laterally projecting assembly component can be formed separately from the coupling device on the dental cap.

An advantageous form of embodiment envisages that the base structure can be divided into base part structures to each of which one or more dental caps with component holders can be detachably coupled. The base structure can be divided, for example, by cutting the elastic material of the base structure. In this way separate part systems are produced which have one section of the base structure of elastic material, one or more dental caps detachably fastened thereto and one or more corresponding bracket holders. More particularly a part system can be produced with precisely one dental cap so that positioning of a corresponding component for precisely one tooth is possible.

In a further development it is envisaged that the coupling component is designed in one piece with the component holder. Including the dental cap in the one-piece system can also be envisaged. In this case production takes place by means of reaming the one-piece system, with or without the inclusion of the coupling component, from a material block.

### DESCRIPTION OF PREFERRED EMBODIMENTS

Embodiments will be described in more detail below with the aid of preferred examples with reference to the figures of a drawing. Here show:

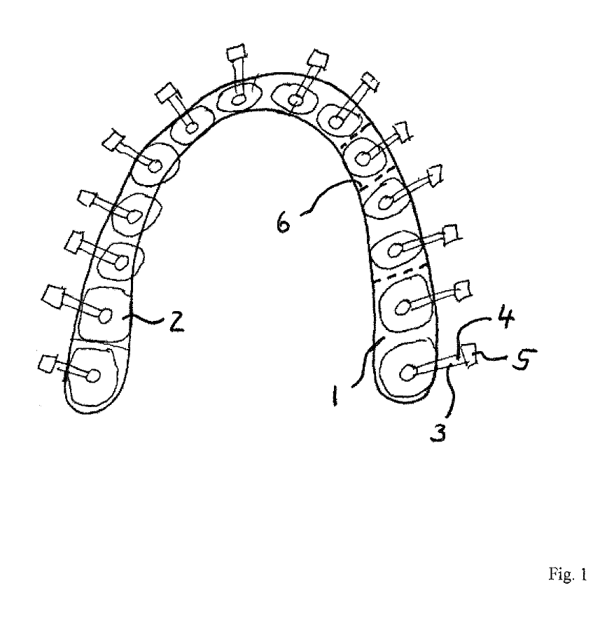

FIG. 1 a schematic view from below of a system with an essentially horseshoe-shaped base structure of elastic material with dental caps and component holders formed thereon,

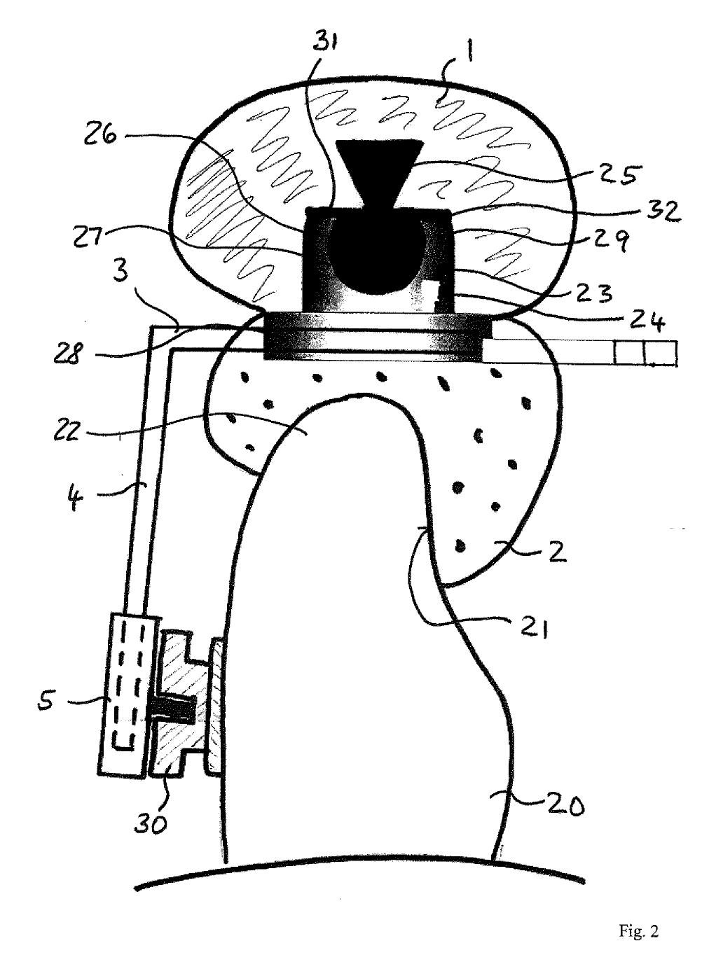

FIG. 2 a schematic view in cross-section of a tooth with a mounted dental cap and component holder formed thereon,

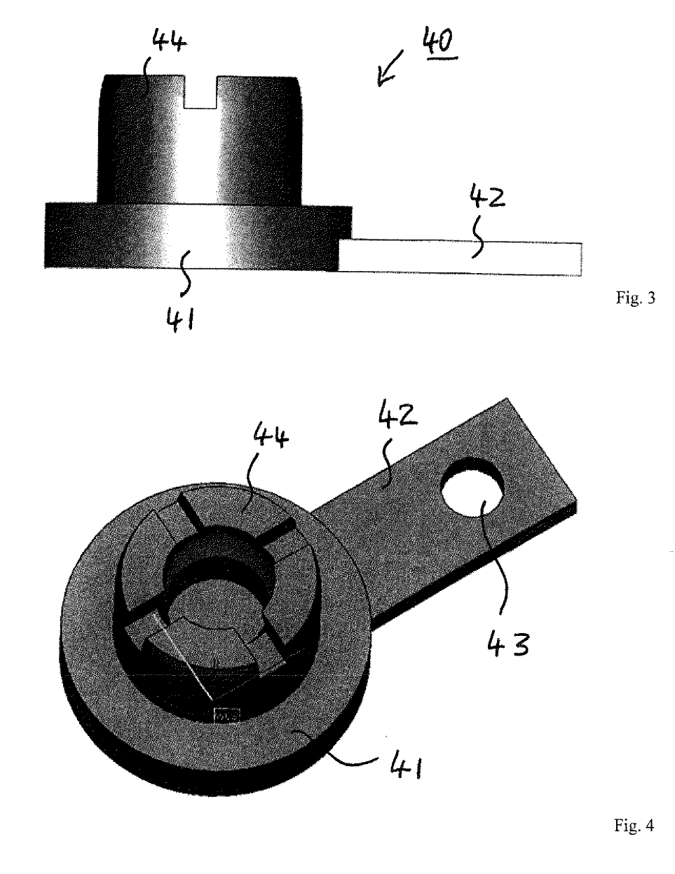

FIG. 3 a coupling component for a dental cap from the front,

FIG. 4 a perspective view of the coupling component in FIG. 3,

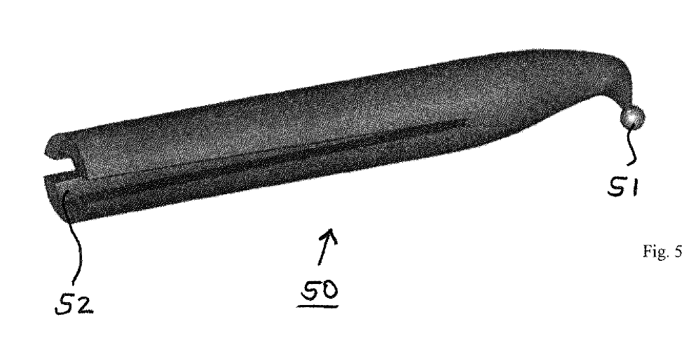

FIG. 5 a perspective view of a positioning aid,

FIG. 6 a perspective view of a further coupling component for a dental cap,

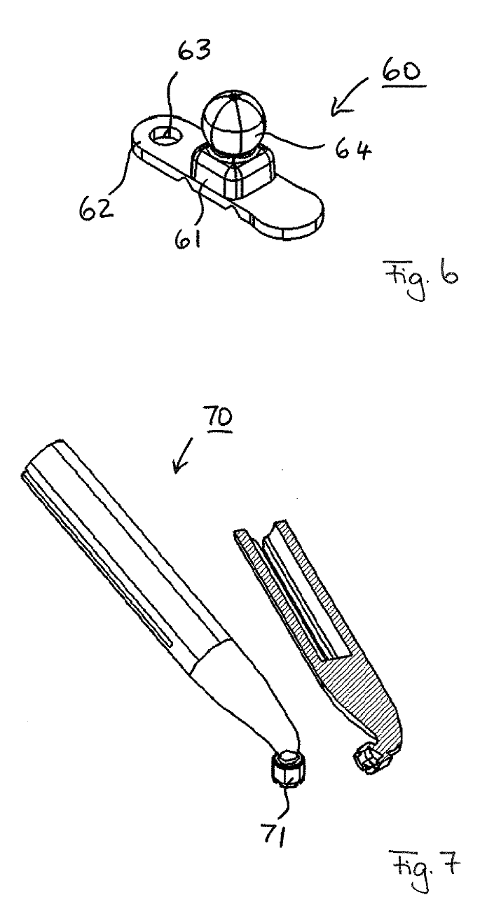

FIG. 7 a perspective view of a further positioning aid for the further coupling component from FIG. 6,

FIG. 8 views of corresponding coupling components for the further coupling component from FIG. 6,

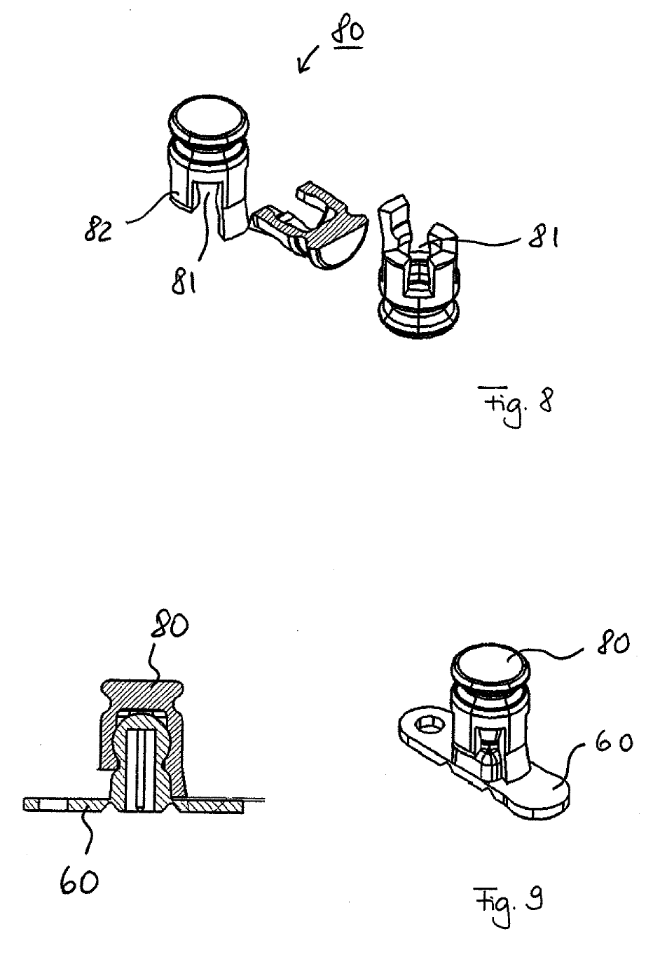

FIG. 9 an arrangement with the further coupling component from FIG. 6 as well as the corresponding coupling component from FIG. 8,

FIG. 10 another form of embodiment of a corresponding coupling component,

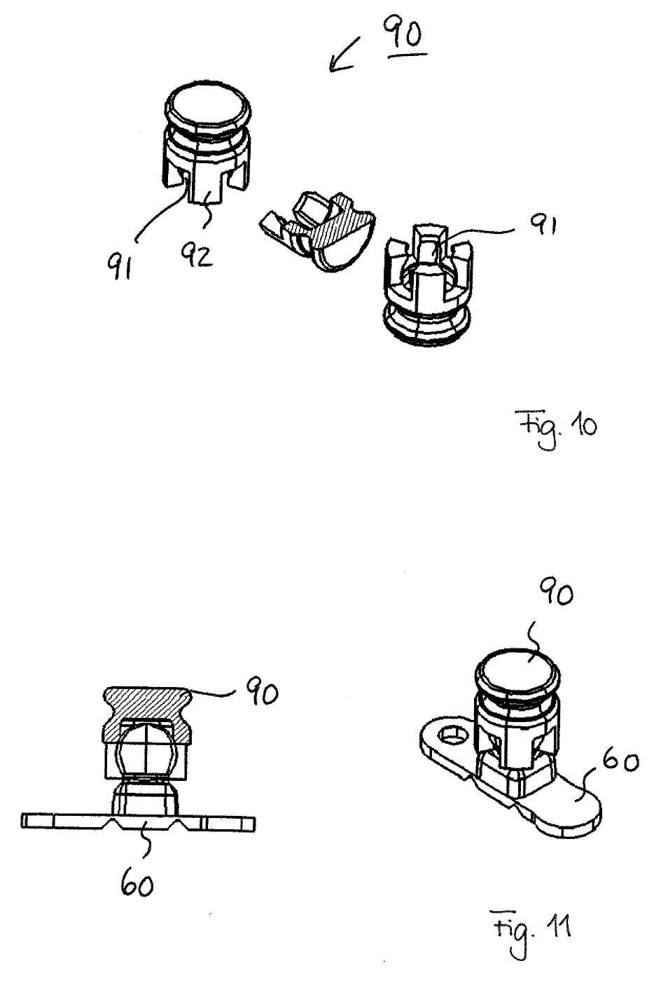

FIG. 11 an arrangement with the further coupling component from FIG. 6 as well as the other form of embodiment of the corresponding coupling component from FIG. 10,

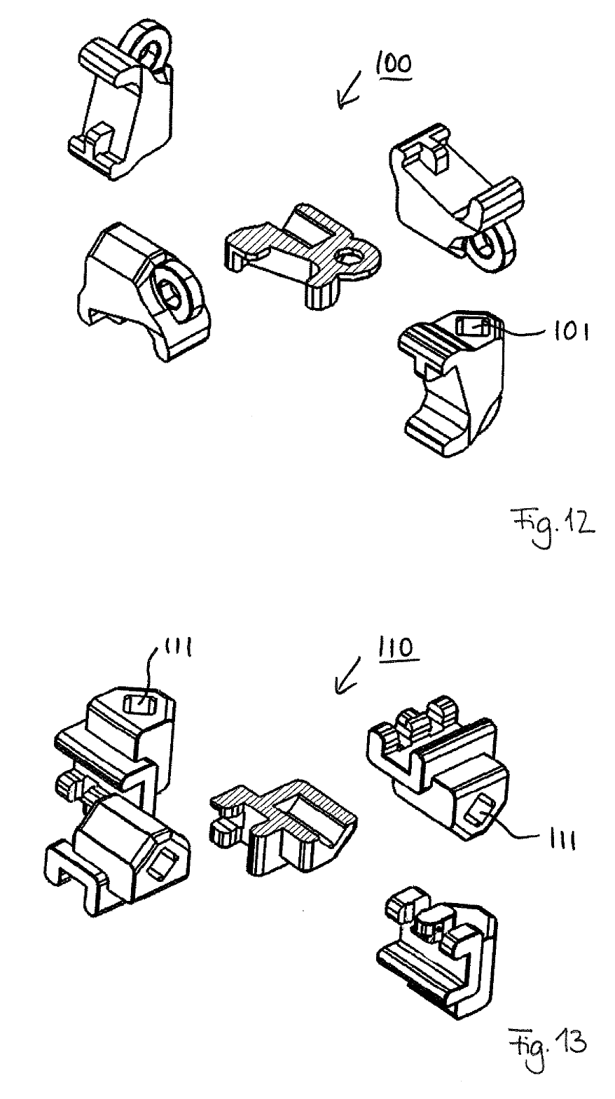

FIG. 12 views of a component holder designed as a bracket adapter,

FIG. 13 views of a further component holder designed as a bracket adapter,

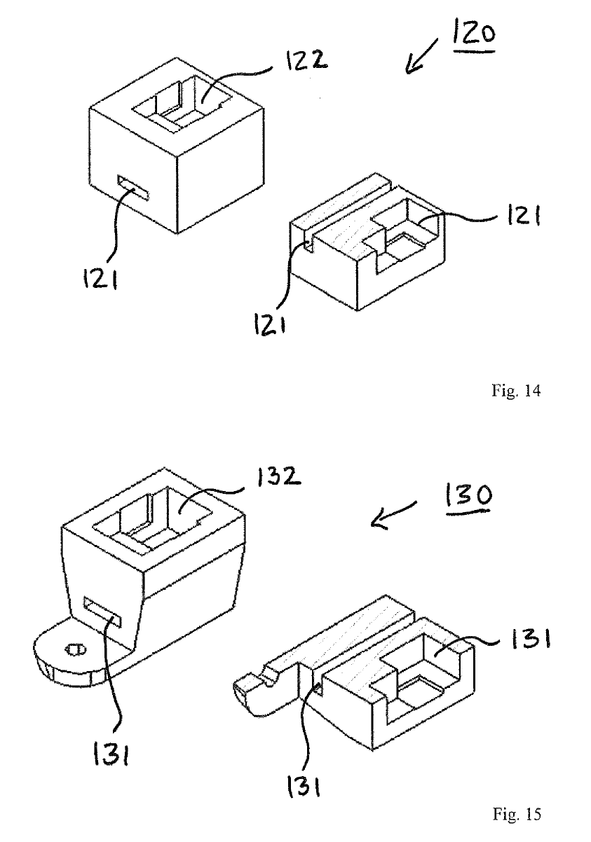

FIG. 14 views of another component holder designed as a bracket adapter and

FIG. 15 views of a further form of embodiment of a component holder designed as a bracket adapter.

FIG. 1 shows a schematic view of a system for positioning orthodontic brackets with an essentially horseshoe-shaped base structure 1 made of elastic material, on which several dental caps 2 are detachably arranged. Fastened to the dental caps 2 is a corresponding component holder 3, designed as a bracket holder in the shown form of embodiment, in which on a retaining bracket 4, namely at its distal end, a component adapter 5, designed as a bracket adapter in the shown form of embodiment, is arranged, which serves to hold a component in the form of a bracket (not shown) which is in contact with the surface of the corresponding tooth of the patient. The system for positioning orthodontic brackets in FIG. 1 makes it possible to produce individual part systems in that the base structure 1 of elastic material is divided, for example along the partition lines 6 shown as dashed lines in FIG. 1.

The system for positioning orthodontic components, more particularly brackets, is produced, for example, in that the dental caps 2 are produced with a negative impression of the corresponding tooth of the patient on a model, made of a solid plastic material for example. The base structure 1 with the dental caps 2 detachably fastened thereon is then mounted on the model of the patient's teeth row. The bracket holders 3, which are made of a rigid material such as a metal or wire material for example, make it possible to position the bracket held on the corresponding tooth in the model in any desired manner on the surface of the tooth, in that the bracket holder 3 is curved accordingly. The thus produced system can then be removed from the tooth row model and mounted on the patient's teeth in the usual manner. The presence of the base structure 1 of elastic material facilitates both the detaching of the system from the model as well as correct mounting on the patient's teeth. The detachable fastening of the dental caps on the underside of the base structure 1 allows the user to adapt the system individually for different therapy and treatment situations in that all, or only certain positions of the teeth row are fitted with a corresponding dental cap 2 with a bracket holder 3 formed thereon.

FIG. 2 shows in cross-section a tooth 20 with the mounted dental cap 2. On the underside the dental cap has a retention fixture 21 which interlocks with an upper area 22 of the tooth 20. The dental cap 2 is coupled via coupling component 23 to the base structure 1, which has a coupling component 24 on the dental cap 2 as well as a corresponding coupling component 25 on the base structure 1. A spherical head 26 on the corresponding coupling component 25 is borne in a spherical recess 27 on the coupling component 24. In the illustrated form of embodiment the spherical head 26 is made of an elastic material so that is snaps into the spherical recess 27, which is preferably also made of an elastic material, more particularly a tough elastic material, in an interlocking manner. In this way a detachable connection is created.

In the form of embodiment shown in FIG. 2 the coupling component 24 on the dental cap 2 is designed with a base section 28 as well as a coupling section 29 formed thereon in which the spherical recess 27 is arranged. Fastened to the base section 28 is the bracket holder 3, which in the illustrated embodiment has the holding arm 4, at the distal end of which the bracket adapter 5 is formed, which holds a bracket 30 to the side of the tooth 20 on the tooth surface and outside the retention fixture 21, whereby in the shown embodiment the bracket is arranged completely outside the retention fixture 21. In one embodiment it can be envisaged that the bracket 30 and/or the holding arm 4 and/or the bracket adapter 5 are at least partially set into the material of the dental cap 2.

FIG. 2 also shows that a marginal projection 31 on the corresponding coupling component 25 rests on an upper edge surface 32 of the coupling section 29. In the illustrated form of embodiment corresponding surfaces lie on each other. This reinforces the mechanical stability of the relative position of the coupling component 24 and the corresponding coupling component 25 with regard to each other. More particularly tilting is prevented.

FIG. 3 shows another form of embodiment of a coupling component 40, comparable with the coupling component 24 in FIG. 2, in which on a base section 41 a retention section 42 with an aperture 43 (cf. FIG. 4) is formed. The retention section 42 allows the user to remove the corresponding dental cap 2 with the coupling component arranged thereon from the tooth, for example. For instance, the user can apply a pair of tongs to the retention section 42. FIG. 4 shows a perspective view of the retention component 40. On the base section 41 there is a coupling section 44 which on producing the coupling device serves to take up a corresponding coupling element (not shown).

FIG. 5 shows a perspective view of a positioning aid 50 which has a spherical head 51 at the forward end. In addition there is a holder 52 with a slit so that the positioning aid 50 can be mounted on a carrier. The positioning aid 50 can be used to position dental caps 3 on the tooth when the base structure 1 is removed. The spherical head 51 of the positioning aid then detachably engages in the spherical recess on the coupling component and allows the user to move the dental cap and thereby the bracket relative to the tooth 20.

In another form of embodiment (not shown) the coupling of the spherical head of the positioning aid 40 to a configuration of the coupling component can take place in that on an outer surface on the coupling component several spherical coupling elements are arranged, which are spaced in such a way that the spherical head 51 snaps into an intermediate space and is therefore detachably connected to the coupling component.

FIG. 6 shows a perspective view of a further coupling component 60 in which on a base section 61 a retention section 62 with an aperture 63 is formed. The retention section 62 allows the user to remove the corresponding dental cap 2 with the coupling component arranged thereon from the tooth, for example. For instance the use can apply a pair or tongs or a probe on the retention section 62. On the base section 61 a coupling section 64 is formed as a spherical head, which serves to take up a corresponding coupling element when producing the coupling device (cf. FIGS. 8 to 11 bottom).

FIG. 7 shows view of a further positioning aid 70, which at the forward end has a retention fixture 71. The further positioning aid 70 can be used to position dental caps on the tooth when the base structure is removed. The retention fixture 71 then grips over the coupling section 64 on the further coupling component 60. The positioning aid 50 as well as the further positioning aid 70 can be provided with a joint (not shown) which makes pivoting of the forward and rear section of the positioning aid possible.

FIG. 8 shows views of a corresponding coupling component 80 which has an elastic spherical head retention fixture 81 which is surrounded by several column sections 82. FIG. 9 shows views of an arrangement in which the corresponding coupling component 80 from FIG. 8 is detachably arranged on the further coupling component 60 from FIG. 6.

FIG. 10 shows views of a further corresponding coupling component 90, in which in contrast to the embodiment in accordance with FIG. 8, the column sections 92 surrounding a spherical head retention fixture 91 are of the same length. FIG. 11 shows an arrangement in which the further corresponding coupling component 90 from FIG. 10 is arranged on the further coupling component 60 from FIG. 6.

FIGS. 12 and 13 show views of a bracket adapter 100, 110 respectively. The bracket adapters have a retention pocket 101, 111 into which on fastening the corresponding bracket adapter 100, 110 to the holding arm 4 (cf. FIG. 2) the latter is inserted so that friction fitting occurs. Other embodiments of the coupling between the holding arm 4 and bracket adapter can also be envisaged

FIGS. 14 and 15 show views of further bracket adapters 120, 130. The bracket adapters 120, 120 have a retention pocket 121, 131 into which on fastening the corresponding bracket adapter 120, 130 to the holding arm 4 (cf. FIG. 2) the latter is inserted so that friction fitting occurs. The bracket adapters 120, 130 each have a bracket retention fixture 122, 132.

The features disclosed in the above description, the claims and the drawing can be of relevance both alone and in any combination for implementing the invention in its various embodiments.

1-11. (canceled)

12. A system for positioning orthodontic brackets comprising:
a base structure made of an elastic material;
at least one dental cap detachably arranged on the base structure by a coupling device, wherein at least one dental cap has a retention fixture on an underside, the retention fixture corresponding to a tooth for interlocking mounting on the tooth; and
at least one bracket holder formed on the at least one dental cap and configured to position an orthodontic component on a corresponding tooth at least partially outside the retention fixture when mounting the at least one dental cap.

13. The system according to claim 12, wherein the coupling device is formed with a coupling component on the at least one dental cap and a corresponding coupling component on the base structure, whereby the coupling component and the corresponding coupling component couple in a detachable manner.

14. The system according to claim 12, wherein the at least one bracket holder is arranged on the coupling component.

15. The system according to claim 13, wherein the coupling component is at least partially set into at least one of the at least one dental cap and the corresponding coupling component into the base structure.

16. The system according to claim 13, wherein the coupling component has a coupling structure which is still configured to couple to a positioning aid in an uncoupled state in which the at least one dental cap is uncoupled from the base structure.

17. The system according to claim 13, wherein in a coupled state in which the dental cap is coupled to the base structure, the coupling component is essentially completely surrounded by the base structure and the at least one dental cap.

18. The system according to claim 12, wherein the coupling device is formed with a snap coupling.

19. The system according to claim 12, wherein the at least one bracket holder has a holding arm borne on the at least one dental cap and a component adapter formed thereon, on which the orthodontic component is held in a detachable manner.

20. The system according to claim 12, wherein the at least one bracket holder is detachably arranged on the at least one dental cap.

21. The system according to claim 12, wherein the base structure is divided in a plurality of base part structures, to each of which one or more dental caps with bracket holders are detachably coupled.

22. The system according to claim 13, wherein the coupling component is produced in one piece with the at least one bracket holder.
